(19) United States
(12) Patent Application Publication
(10) Pub. No.: US 2015/0140536 A1
(43) Pub. Date: May 21, 2015

(54) FLEXIBLE OPTICAL FILM MATERIAL AND METHOD FOR SIMULATING ONE OF A MULTIPLICITY OF OPTHALMIC CONDITIONS REPRESENTATIVE OF A DISEASE STATE

(71) Applicants: Marc Chase WEINSTEIN, Mineola, NY (US); Gregory R. JORDAN, Cumming, GA (US)

(72) Inventors: Marc Chase WEINSTEIN, Mineola, NY (US); Gregory R. JORDAN, Cumming, GA (US)

(73) Assignee: Gregory R. Jordan, Cumming, GA (US)

(21) Appl. No.: 14/542,596

(22) Filed: Nov. 15, 2014

Related U.S. Application Data
(60) Provisional application No. 61/905,136, filed on Nov. 15, 2013.

(51) Int. Cl. G09B 23/28; B29D 11/00; G09B 9/00

(52) U.S. Cl. CPC G09B 23/28; G09B 9/00; B29D 11/00788; B29K 2101/12
USPC 434/262; 264/1.6

(57) ABSTRACT

A flexible, yet self-supporting, optical film processed to include at least one curable resin cured on selected areas thereof. The processed film is useful in a method for simulating one of a multiplicity of opthalmic conditions representative of a disease state or vision disorder. The resin has a surface (or interface with the film) that forms an optically active profile variation in a selected area of the film, that is responsible for refraction or transmission of light, or both, which simulates the one or more opthalmic conditions representative of the disease state. The resin optionally has an opacity variation and optionally has a color variation, each optional variation optionally assisting the film to simulate the one or more opthalmic conditions, such as metamorphopsia.

### CROSS-REFERENCE TO RELATED APPLICATIONS

For US purposes only, this application claims priority of prior U.S. Provisional Patent Application U.S. Ser. No. 61/905,136, filed Nov. 15 2013. The entire disclosure of this prior patent application is incorporated herein by reference in its entirety.

### BACKGROUND

1. Field of the Invention

Embodiments of the present invention generally relate to optic simulators and, more particularly, to a flexible optical film material and method for simulating one of a multiplicity of opthalmic conditions representative of a vision disorder or a disease state.

2. Description of the Related Art

Metamorphopsia is a type of distorted vision in which a grid of straight lines, such as Amsler grid image 10 in FIG. 1A, appears wavy and parts of the grid may appear blank, such as in Amsler grid image 12 in FIG. 1A. See Amsler grid image 10 in FIG. 1A. People with this condition often first notice this effect when looking at mini-blinds in their home.

This vision effect is mainly associated with macular degeneration, particularly age-related macular degeneration with choroidal neovascularization. Other conditions that can present with complaints of metamorphopsia include pathological myopia, presumed ocular histoplasmosis syndrome, choroidal rupture and multifocal choroiditis. (source: wikipedia)

It is desirable for eye care professionals to visually simulate the metamorphopisa disorder by way of an optical viewing aid, for the purposes of training the otherwise non-visually impaired, for promoting corrective procedures, and general education of the effects of the disorder. With such a viewing aid simulator, the user is able to experience the visual perception of metamorphopsia while viewing a natural setting. FIGS. 1B and 1C illustrate such images via distortions in areas 14 and 16, respectively.

Existing vision disorder simulators utilize individual rigid disks which are relatively thick in cross-section, heavy, and costly to produce due to processing limitations imposed by the rigid nature of the materials used, such as glass or rigid plastic. It is also known, for example from U.S. Pat. No. 5,737,056, to make a thin transparent film press-on or contact lens that simulates for an eyeglass wearer a vision disorder, which transparent film press-on or contact lens can be placed “piggy-back” style on a pair of eyeglasses worn by the wearer.

There exists a need for a lightweight, thin cross-section vision disorder simulator which can be produced at low cost using high-volume manufacturing equipment.

### SUMMARY

In accordance with one or more embodiments, the invention is a flexible, yet self-supporting, optical film that is processed to include at least one curable resin cured on selected areas thereof. The processed film is useful in a method for simulating one of a multiplicity of opthalmic conditions representative of a disease state. The resin has a surface (or interface with the film) that forms an optically active profile variation in a selected area of the film, that is responsible for refraction or transmission of light, or both, which simulates the one or more opthalmic conditions representative of the disease state. The resin optionally has an opacity variation and optionally has a color variation, each optional variation optionally assisting the film to simulate the one or more opthalmic conditions.

In another embodiment, the invention is a flexible optical film material for simulating metamorphopsia, comprising: at least one flexible substrate film, and at least one curable resin, the resin having a surface or interface whose optically active profile variation is responsible for the refraction or transmission of light, or both, such that an image aberration simulating metamorphopsia is presented.

By utilizing a flexible substrate film roll and a curable resin in place of rigid optics of the prior art, production rates can be dramatically increased through the use of roll-to-roll manufacturing and inspection processes, thereby significantly lowering production costs. Advantages in manufacturing include the use of well known techniques for high speed web-based casting or thermoforming of the resin instead of low speed platen press molding, automated rotary die-cutting instead of low speed dicing or sawing and high speed roll-to-roll inspection instead of manual part inspection.

By using a continuous base self-supporting substrate having optical areas thereon, in combination with curable resin processing in the optical areas while in roll form, high speed/low cost manufacturing is facilitated. A simulator optic in accordance with embodiments of the invention does not require any further supporting structure in order to be functional, since the base substrate film of the described simulator optic provides enough rigidity for the combination optic to be a standalone product, yet flexible enough to be wound up into a roll for cost effective manufacturing. Typical prior art simulator optics require attachment to further optics for support. Furthermore, a simulator optic in accordance with embodiments of the invention may include optional attachment to a box or frame, although such attachment is not required.

Further benefits of a film roll based construction include lighter weight, so that if the material is incorporated into a wearable frame or housing, less force is exerted on the bridge of the nose or ears. Another benefit includes the ability to easily cut and fold the material so that a finished, wearable product having optical effects for disease state simulation can be made from a single film cutout from the roll. Another advantage includes a thin cross-sectional profile compared to a molded lens for example, so that the product could be mailed in a flat envelope, enabling distribution to a wider audience. Other advantages that flow from the use of film roll material for the simulator optic include low cost manufacturing and molding compared to more expensive manufacturing/molding techniques and lower cost materials than ground glass or thick molded lenses.

By flexible substrate film roll is meant a continuous roll of transparent polymeric base material often used in the graphic arts and printing industry. Such materials are supplied commercially in roll form according to specified material chemical composition, gauge thickness, roll width, roll length, surface finish (e.g.: gloss vs matte), clarity (degree of light transmission), and with or without surface treatments for coating adhesion. The term ‘optically active region’ is defined herein as an area having a light transmissive and/or light refractive curvature profile, and/or opacity variations, gradual or stepped (where the stepped variations are equivalent to cuts make in the optical area so as to simulate , intended to simulate an ophthalmic condition as perceived by the viewer, and or absence or presence of coloration. Contiguous areas surrounding optically active regions may be clear, translucent, opaque, reflective, overprinted, or not otherwise specified, and referred to here as optically inactive.

### BRIEF DESCRIPTION OF THE DRAWINGS

FIGS. 1A, 1B and 1C noted above, illustrate visual distortions suffered by persons with metamorphopsia;

FIG. 2 illustrates a standalone format for a simulator optic in accordance with one embodiment of the invention;

FIG. 3 illustrates a standalone format for a simulator optic in accordance with another embodiment of the invention;

FIG. 4 illustrates a standalone format for a simulator optic in accordance with a further embodiment of the invention;

FIG. 5 illustrates a standalone format for a simulator optic in accordance with an even further embodiment of the invention;

FIG. 6 illustrates a flexible film roll having selected areas of curable resin thereon, constructed in accordance with one embodiment of the invention for mass production of a simulator optic in accordance with FIG. 2;

FIG. 7 illustrates a flexible film roll having selected areas of curable resin thereon, constructed in accordance with one embodiment of the invention for mass production of a simulator optic in accordance with FIG. 5;

FIG. 8 illustrates details of a simulator optic and manufacturing technique using a thermoformed embossment, in accordance with one embodiment of the invention;

FIG. 9 illustrates details of a simulator optic and manufacturing technique using a cured resin, in accordance with another embodiment of the invention;

FIG. 10 illustrates details of a simulator optic and manufacturing technique using a cured resin sandwiched between two layers of roll film, in accordance with a further embodiment the invention;

FIG. 11 illustrates details of a simulator optic and manufacturing technique using two cured resins sandwiched between two layers of roll film, in accordance with an even further embodiment the invention;

FIG. 12 illustrates in block diagram form a method and apparatus for manufacturing a simulator optic using roll film processing in accordance with one embodiment the invention;

FIG. 13 illustrates in block diagram form a quality control process for roll film manufactured in accordance with FIG. 12;

FIG. 14 illustrates in block diagram form a finish processing for roll film manufactured in accordance with FIG. 12;

FIGS. 15A and 15B illustrate perspective views of the viewer side and lens side, respectively, of a box viewer for supporting therein an optical film cutout of the type shown in FIG. 2.

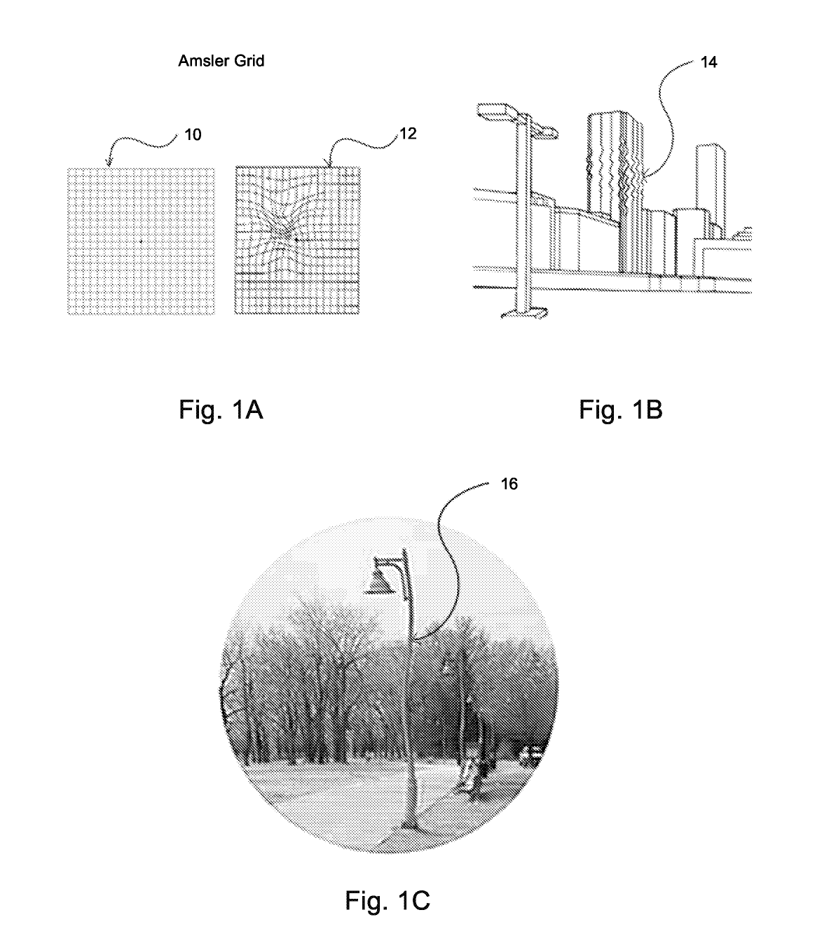

### DETAILED DESCRIPTION

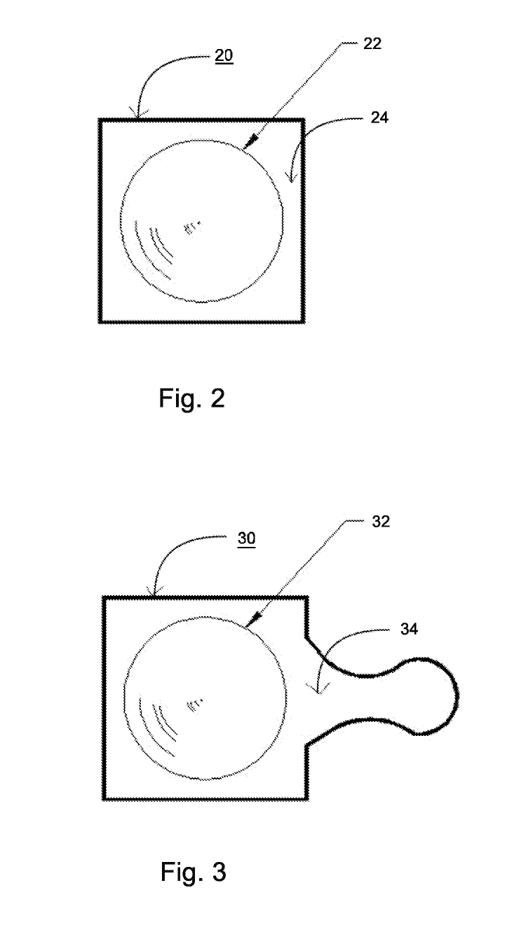

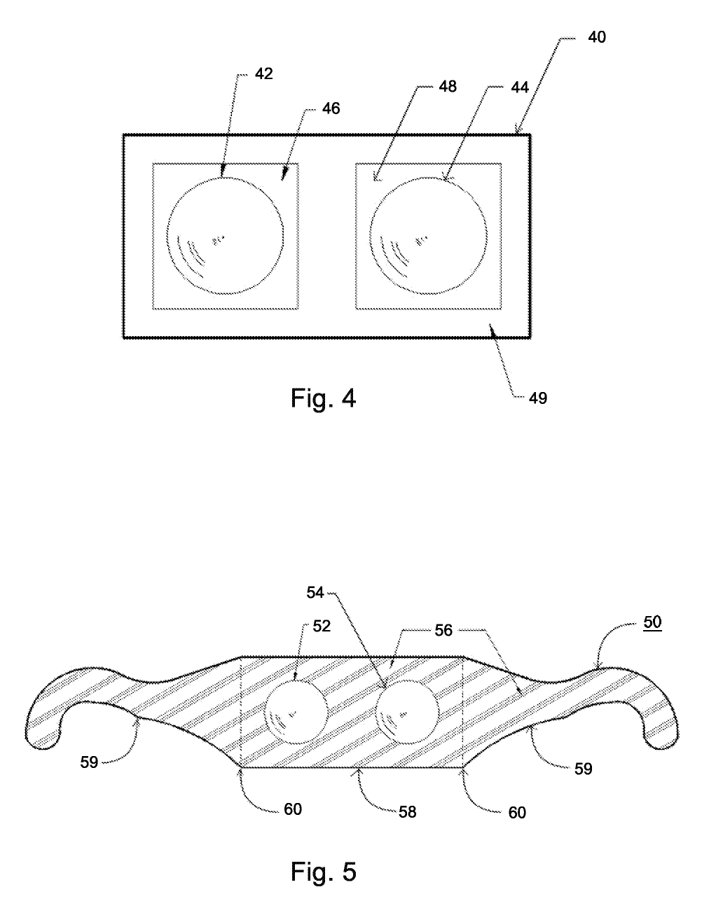

Suitable formats for utilizing the simulator optic in accordance with a embodiments the invention include but are not limited to:
as shown by FIG. 2, a standalone (for example die-cut from a larger piece of film roll) film material 20 having a single optically active region 22 and optionally surrounding inactive optical region 24;
as shown by FIG. 3, a standalone material 30 with one or more optically active regions 32 and optionally having an optically inactive handle region 34;
as shown by FIG. 4, a cutout material with one or more optically active regions for subsequent incorporation into a frame, viewing box, viewing cylinder, etc. For example, an optical simulator 40 die-cut from a flexible film roll material with two optically active areas 42 and 44 and surrounding inactive optical areas 44 and 46 for incorporation into paper or cardboard glasses frames (for example), where an optically inactive film portion 49 is adhesively bonded to the frames; and
as shown by FIGS. 5 and 7, a cutout 50 from a single piece of flexible film roll, whereby the optically active regions 52 and 54 and inactive regions 56 in the shape of a plastic frame 58 are included, such that arms 59 of the frame 58 may be bent along fold lines 60 to form a set of wearable glasses, as shown by FIG. 5, and even later on in this description, by FIG. 7.

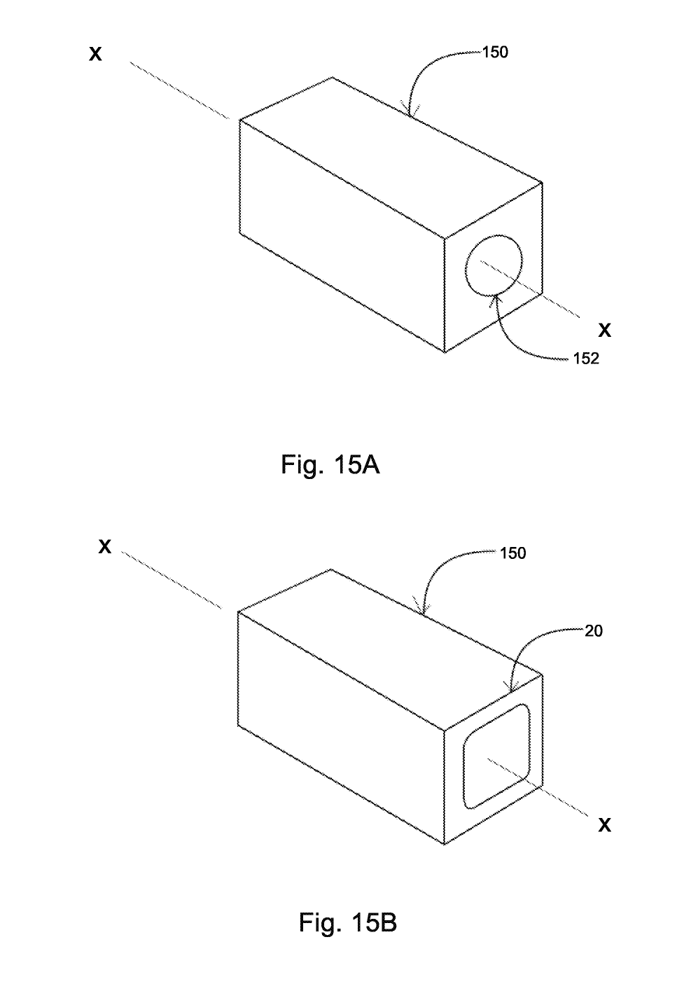

In some embodiments the flexible simulator optic may be used alone as a standalone simulator optic, or incorporated into any number of final assemblies for ease of use, such as inserts into:
durable frame glasses or fashion eyewear;
inexpensive paper eyewear frames;
incorporated into a simple tube or box viewer, such as a four inch tube having a one inch diameter with the optical film mounted in one end or a four inch long box having a one or two inch square cross section, with the optical film mounted in one end. In this regard, FIGS. 15A and 15B illustrate perspective views of the viewer side and lens side, respectively, of a box viewer 150 for supporting therein an optical film cutout 20 of the type shown in FIG. 2. The viewer side has a viewing port or window 152 centered with a longitudinal axis x-x in one end of the box 150, and the lens side has the optical film cutout 20 supported in the end of the box opposite the window 152 and also aligned with the longitudinal axis of the window 152;
as a large display, incorporated into a medical device, etc.

In some embodiments, the flexible film material of the simulator optic may be manufactured on flexible substrate film typically found in roll form for high volume manufacturing. Suitable flexible film substrate materials include polyethylene terepthalate (PET), polypropylene(PP), polystyrene(PS), polyamide (nylon), polyethylene napthalate (PEN), thermoformable films, among others. Suitable film thicknesses for flexibilty include 0.6 to 10 mil.

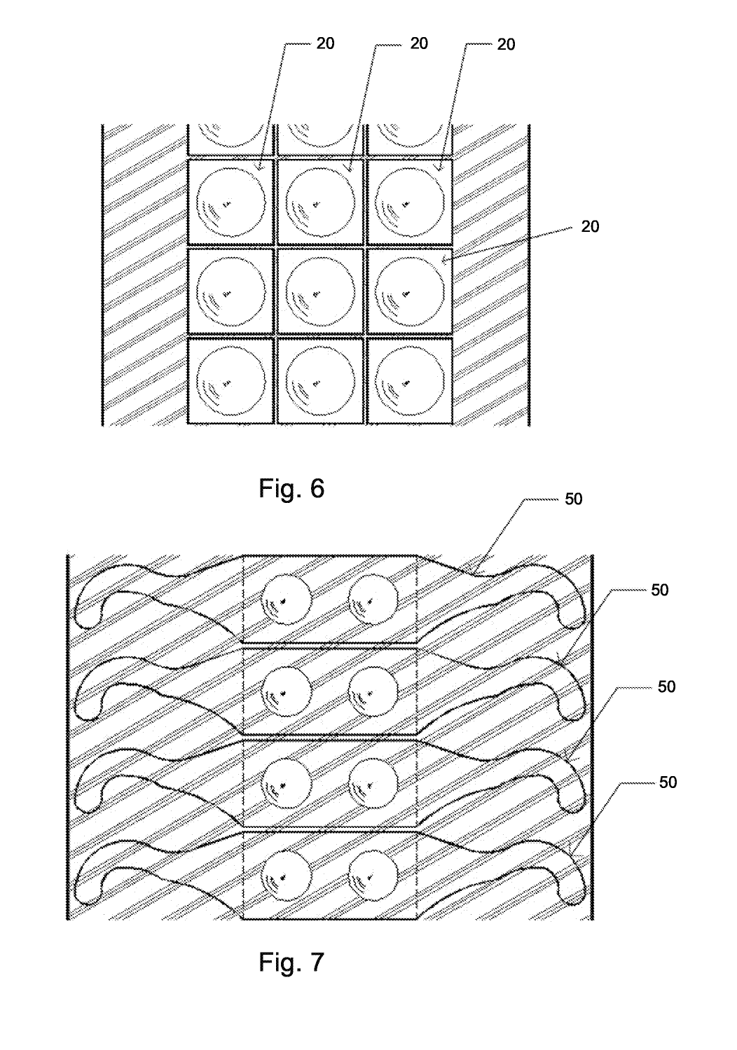

In some embodiments, the simulator optic may be provided with optically active and inactive functionality using sheet and roll based manufacturing equipment such as printing presses, rotary embossing equipment, cylindrical molds, hot stamping, and the like. Graphical layouts for the simulator optic on the flexible substrate film may include multiple units of the simulator optic so that a large number of units of the simulator optic may be produced using rotary production methods, or roll-to-roll manufacturing. Example depictions of graphically layouts on a single substrate film are shown in FIGS. 6 and 7 for the simulator optic of FIGS. 2 and 5, respectively.

Suitable curable resins for creating optically active regions for disease state simulation include polymethyl methacrylate(PMMA), polyurethane, epoxies, acrylics, using one of various and well known curing methods, including heat, cationic, free-radical and isocyanate curing techniques, among others.

More specifically, suitable rotary production tool surfaces which act to form the desired optical profile by embossing, molding or casting, hot stamping and the like, include materials common in the art of roll-to-roll manufacturing. These may include but are not limited to polished steel, chrome, nickel, ceramic or other non-reactive surface materials that allow “non-stick” contact with resin or flexible film. Other suitable materials include those applied as a thin surface layer by physical vapor deposition (PVD) such as silver, chrome, titanium, gold, glass (such as Pyrex) or other elemental oxides or nitrides selected for properties that provide hardness, heat, chemical, and scratch resistance, and level of gloss among others. Other suitable materials for rotary tool surfaces may include engineered plastics such as polytetrafluoroethylene (PTFE) or polypropylene.

A suitable optical film roll material, for example, would be a 3 mil thickness PEN (polyethylene napthalate) film product designation Teonex®Q51 available from Tekra 16700 West Lincoln Avenue, New Berlin, Wis. 53151which may be chosen having high clarity and gloss and supplied in a 12″ width roll with a length of 3,500 linear feet of material on the roll.

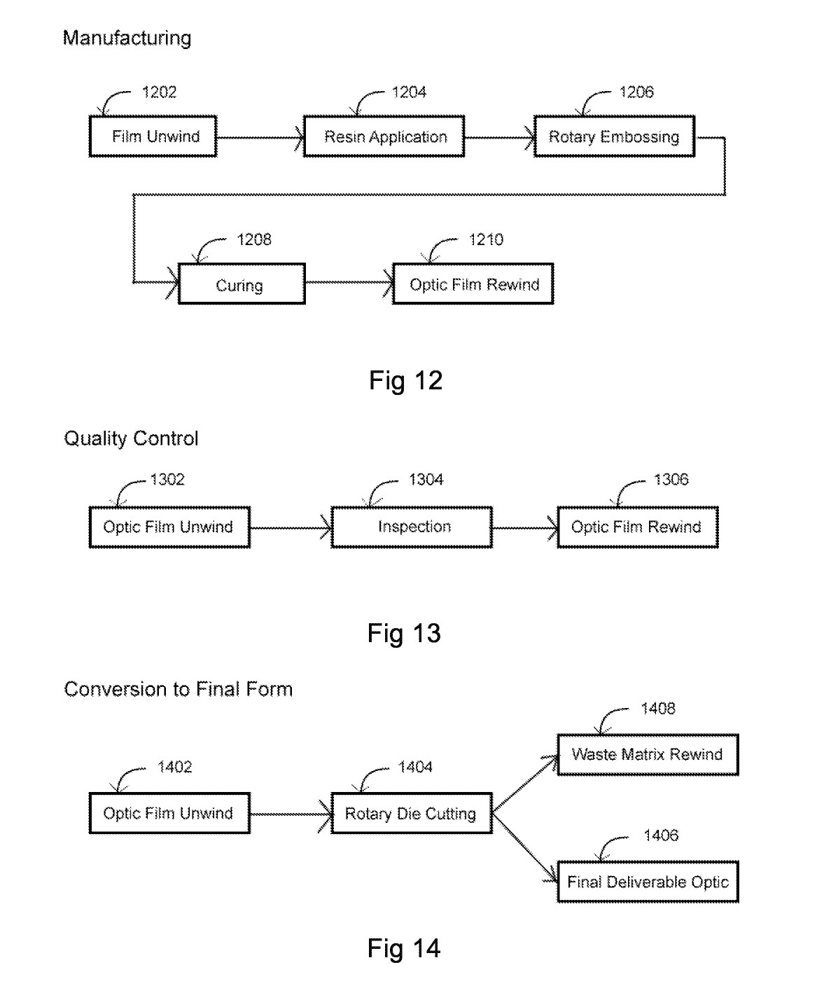

FIG. 12 illustrates an exemplary manufacturing method and apparatus, where the material from this roll may then be conveyed through a machine by unwinding at an unwinding station 1202, passing the roll film through a resin application station 1204 where the liquid resin is applied to the film at desired optical areas, such as shown in FIGS. 2-5. The film is then passed through one or more embossing, printing or casting stations 1206 where the film is processed to form the desired optical shape by contacting a rotating cylindrical mold that was filled with the curable liquid resin at stage 1204. Simultaneously or slightly thereafter, at stage 1208, heat, pressure or actinic radiation (e.g.: UV or electron beam curing) is applied to the roll film/liquid resin combination in order to harden the resin. As a result of the curing, a copy of the mold surface bonds to the polymeric base film, thereby creating the optcal active and inactive areas shown in FIGS. 2-5. The film then passes to a rewinding station 1210 that ends the manufacturing process, where a rewind machine winds the processed film back up into a roll.

This process allows continuous “casting” of the cylindrical mold surface so that copies of the mold surface are generated as quickly as the film is passed through the machine, starting at the film unwind station 1202 and ending at the film rewind station 1210 at the end of the machine.

FIG. 13 illustrates an exemplary quality control process for the film roll having the optical structures thereon. The film is moved from the film rewind station 1210 to an unwind station 1302, where the film roll is unwound. At an inspection station 1304 the film roll is inspected using automated imaging inspection techniques well known by those of ordinary skill in the art to determine the size, shape and quality of the formed optical structures on the film roll. Then, at film rewind station 1306, the quality control process ends with the film being rewound back into a roll.

FIG. 14 illustrates finishing processing, where the roll film having optical structures thereon is converted into a final form useful for commercial applications, such as the shapes shown by FIGS. 2-5. At an optical film unwind station 1402 the film roll is unwound. At a rotary die-cutting station 1404 the film roll is die-cut into the useable shapes noted above using automated rotary die-cutting techniques and equipment well known by those of ordinary skill in the art. Then, at station 1406 the die-cut usable shapes are collected and at station 1408 the roll material left over from the die-cut process is collected as waste at waste rewind film station 1410.

The above steps shown and described with respect to FIGS. 12, 13 and 14 allow manufacture of the inventive simulator optic to benefit from the high speed roll unwinding/rewinding process that can only be achieved by the use of the flexible substrate film process of the current invention.

The curable liquid resin for example, Loctite 3106 available from Henkel Corp. One Henkel Way Rocky Hill, Conn. 06067 is dispensed from a vat (protected from heat, light, etc. to prevent premature curing) through piping or tubing and and having a flow rate regulator so that the resin can be applied between the cylindrical mold and film. Flow rate of the resin is adjusted so that the rotating mold is continuously filled or covered with liquid resin so that the volume applied matches the rate at which cured resin is carried away with the film as it is conveyed through the machine. Viscosity of the resin can be adjusted by formulation, or by temperature of the dispensing vat. Utilizing a pourable/pumpable liquid resin enables high speed roll-to-roll manufacturing because the resin can be dispensed quickly and in a continuous, uninterrupted flow. If the supplying vat becomes low during a production run, more resin can be added to the vat without stopping the production machine.

As noted above with respect to FIG. 12, the roll film can be processed by a variety of different techniques in order to form the optically active and inactive areas in the desired locations on the film.

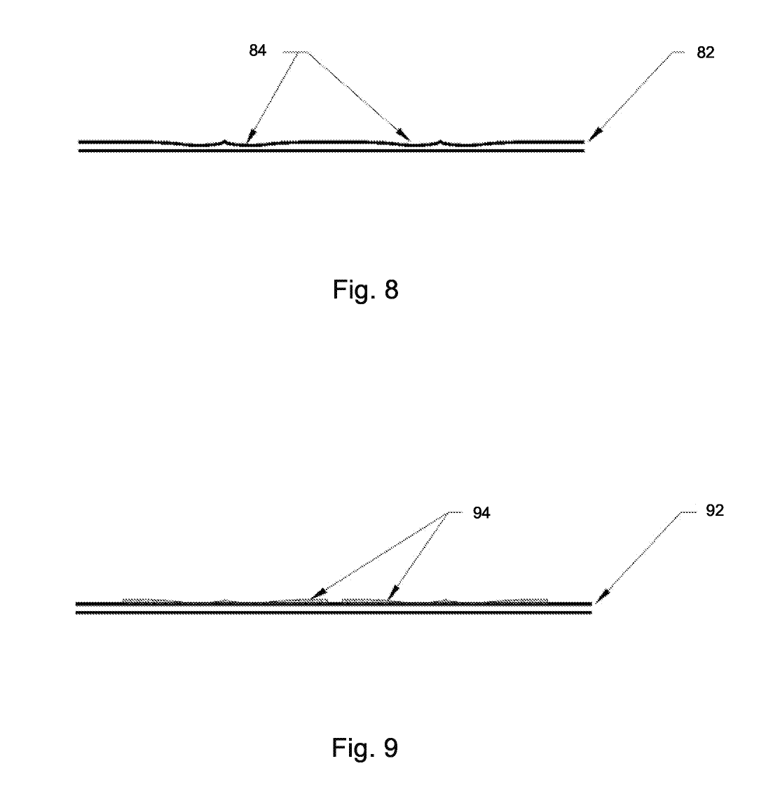

In one embodiment, as shown by FIG. 8, the optically active regions for simulating an ophthalmic condition are provided by thermoforming the desired shape of the optically active region directly into the substrate film by use of a heated flat or cylindrical mold.

In another embodiment, as shown by FIG. 9, the optically active regions for simulating an ophthalmic condition are provided by depositing at least one type of a curable resin 94 in contact areas of the film 92, whereby the resin has been cured against a flat or cylindrical mold.

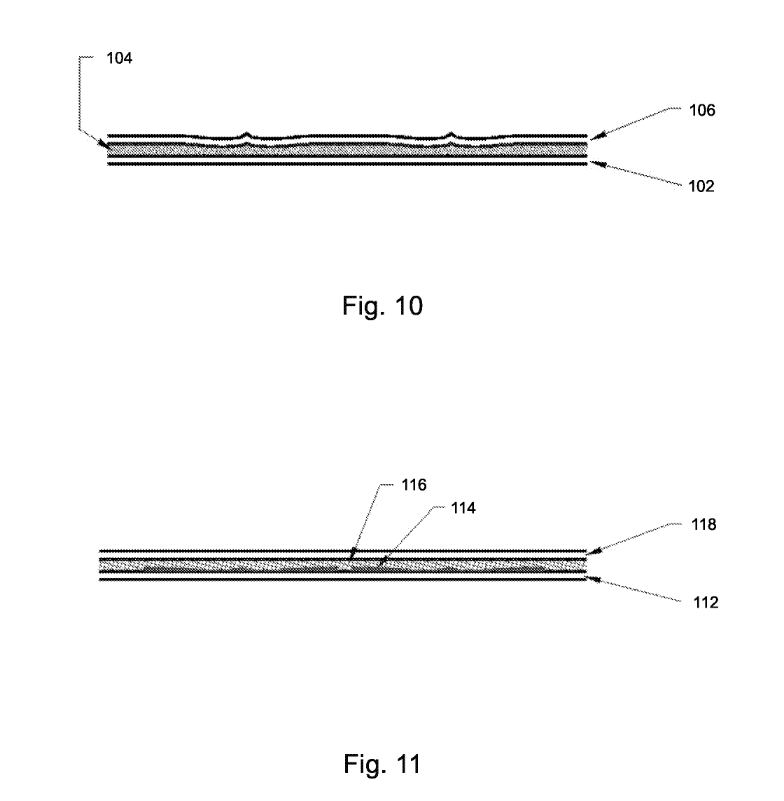

In a further embodiment, as shown by FIG. 10, the optically active regions for simulating an ophthalmic condition are provided by the combination of: a base substrate film 102, at least one curable resin 104 in contact with the substrate film 102, and an outer layer film 106 in contact with the curable resin 104, such that the resin is sandwiched between two films, and whereby a desired curvature profile is provided by the curable resin and the outer layer film.

In an even further embodiment, as shown by FIG. 11, the optically active region for simulating an ophthalmic condition is provided by the combination of: a substrate film 112, a first curable resin 114 in contact with the substrate film 112 and a second curable resin 116 of different composition from the first curable resin 114, in continguous contact with the first curable resin, and an outer layer film 118, such that the first and second resins 114 and 116 are sandwiched between the two films 112 and 118, whereby the desired curvature profile is provided by the interface between the first and second curable resins 114 and 116, and whereby the refractive index of the first curable resin 114 is higher or lower than the refractive index of the second curable layer 116, so that light passing through the material is refracted at the interface between the two curable resins such than an opthalmic condition is simulated.

Example disease state conditions which may be simulated by the current invention include but are not limited to: metamorphopsia, macular degeneration, glaucoma, retinitis pigmentosa, diabetic retinopathy, hemianopsia, cataracts, or other disease states indicated by visual impairment or abnormality.

While the method and apparatus is described herein by way of example for several embodiments and illustrative drawings, those skilled in the art will recognize that the method of making and the flexible optical film material apparatus for simulating one of a multiplicity of opthalmic conditions representative of a disease state, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method of making and the flexible optical film material apparatus for simulating one of a multiplicity of opthalmic conditions representative of a disease state, as will be defined by the claims of a future patent application. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Also, in the above detailed description, numerous specific details are set forth to provide a thorough understanding of invention. However, it will be understood by those skilled in the art that the invention may be practiced without these specific details. In other instances, methods, apparatuses or systems that would be known by one of ordinary skill have not been described in detail so as to not obscure the inventive subject matter.

1. An optic for simulating at least one or more vision disorder, comprising:
a flexible, yet self-supporting, optical film processed to include as an inseparable part thereof, at least one optically active area, which optically active area includes profile variations which cause distortion of a scene when the scene is viewed through the optically active area, thereby simulating the at least one or more vision disorder.

2. The optic of claim 1, wherein the optical film includes in the optically active area a thermoformed distortion of the film.

3. The optic of claim 1, wherein the optical film includes in the optically active area a resin cured on the film so as to cause the profile variations.

4. The optic of claim 1, wherein the vision disorder simulated by the profile variations of the optical film is metamorphopsia.

5. The optic of claim 3, further including a second flexible film positioned on top of the curable resin, so that the curable resin is sandwiched between the first-noted and second flexible films.

6. The optic of claim 5, further including a second curable resin positioned on top of the first-noted curable resin, so that the first-noted and second curable resins are sandwiched between the first and second flexible films.

7. The optic of claim 1, further including an elongate support having an unobstructed view path therein, the support having positioned in line with the view path at one end thereof the processed optical film and at an opposite end thereof a clear window.

8. The optic of claim 2, wherein the curable resin has either one or both of an opacity variation and a color variation.

9. A method for making a vision disorder simulator by roll processing an optical film, comprising:
unrolling a flexible, yet self-supporting, optical film;
rotary-based processing the optical film using rotary-based manufacturing equipment to include as an inseparable part of the optical film a plurality of optically active areas and a plurality of optically active areas, which optically active area includes profile variations which cause distortion of light upon passing therethrough, thereby simulating at least one or more vision disorder; and
separation processing of the processed film, so as to separate the film into a plurality of sections, each section including one or more of the optically active areas.

10. The method of claim 9, wherein rotary-based processing the optical film includes thermoforming a surface of the optical film so as to cause said profile variations in the optically active areas.

11. The method of claim 9, wherein rotary-based processing the optical film includes applying a curable resin to the film so as to cause the profile variations.

12. The method of claim 11, wherein rotary-based processing the optical film includes applying a second flexible film on top of the curable resin, so that the curable resin is sandwiched between the first-noted and second flexible films.

13. The method of claim 12, wherein rotary-based processing the optical film includes applying a second curable resin on top of the first-noted curable resin, so that the first-noted and second curable resins are sandwiched between the first and second flexible films.

14. The method of claim 11, wherein the curable resin has either one or both of an opacity variation and a color variation.
